(19) United States
(12) Patent Application Publication
(10) Pub. No.: US 2012/0124633 A1
(43) Pub. Date: May 17, 2012

(54) Wireless Video Streaming Quality Management for Bandwidth Constrained Cellular Network

(75) Inventors: LIGANG LU, Yorktown Heights, NY (US); Vadim Sheinin, Yorktown Heights, NY (US)

(73) Assignee: International Business Machines Corporation, Armonk, NY (US)

(21) Appl. No.: 12/946,544

(22) Filed: Nov. 15, 2010

(51) Int. Cl. H04N 7/173

(52) U.S. Cl. 725/114

(57) ABSTRACT

A method for wireless video streaming includes determining a backhaul bandwidth of a base station and ongoing traffic between a plurality of wireless clients and the base station, determining a video transcoding policy for each of the wireless clients based on a service agreement of each wireless client, decoding network signaling information, extracting a plurality of video streams based on the decoded network signaling information, and transcoding the plurality of video streams simultaneously upon determining that the ongoing traffic exceeds the backhaul bandwidth. Transcoding is based on a video transcoding policy of a receiving wireless client, video properties of a video stream being transcoded, and the decoded network signaling information.

### BACKGROUND

1. Technical Field

The present disclosure relates to wireless video streaming, and more particularly, to a system and method for wireless video streaming quality management for a bandwidth constrained cellular network.

2. Discussion of Related Art

Wireless video streaming to mobile devices is a growing application for cellular phone service providers. In a 3^{rd} Generation (3G) cellular network, a group of base stations (e.g., cellular towers) is linked to a base station controller via a plurality of T1 lines. The base station controller provides a backhaul bandwidth of about 3-5 Megabits per second (Mbps) to each base station. Each base station provides a connection to about 1,000 cellular clients, of which about 200 clients are active at a given instance. A 4^{th} Generation (4G) cellular network such as, for example, a Long Than Evolution (LTE) cellular network or a Worldwide Interoperability for Microwave Access (WiMAX) cellular network functions in a similar manner as a 3G cellular network, but has a backhaul bandwidth of about 300 Mbps at each base station.

Streaming video content accounts for more than about 50% of all traffic in a typical cellular network. Content providers such as, for example, YOUTUBE®, typically encode a standard definition video stream with a bit rate of about 400 Kilobits per second (Kbps), and a high definition video stream with a bit rate of about 2-4 Mbps. Streaming these video streams to cellular clients is a bandwidth intensive application for both 3G and 4G cellular networks. As a result, cellular clients may experience frequent video playback disruption, degraded video quality, or the refusal of video playback requests. Preloading a video stream to the input buffer of a cellular client's device may improve video playback to a certain degree, however, it may also result in a large response delay, requires a large buffer on the cellular client device, and still results in disruptive video playback after a certain amount of time.

### BRIEF SUMMARY

According to an exemplary embodiment of the present disclosure, a method for wireless video streaming includes determining a backhaul bandwidth of a base station, determining ongoing traffic between a plurality of wireless clients and the base station, determining a video transcoding policy for each of the plurality of wireless clients based on a service agreement corresponding to each of the plurality of wireless clients, decoding network signaling information, extracting a plurality of video streams based on the decoded network signaling information, and transcoding the plurality of video streams simultaneously upon determining that the ongoing traffic exceeds the backhaul bandwidth. The transcoding is based on a video transcoding policy of a receiving wireless client, video properties of a video stream being transcoded, and the decoded network signaling information.

According to an exemplary embodiment of the present disclosure, a video service manager includes a service policy component, a signaling processing component, and a traffic monitoring and transcoding engine. The service policy component is configured to determine a video transcoding policy for each of a plurality of wireless clients based on a service agreement corresponding to each of the plurality of wireless clients. The signaling processing component is configured to decode network signaling information, and extract a plurality of video streams based on the decoded network signaling information. The traffic monitoring and transcoding engine is configured to transcode the plurality of video streams simultaneously upon determining that ongoing traffic between the plurality of wireless clients and a base station exceeds a backhaul bandwidth of the base station. The transcoding is based on a video transcoding policy of a receiving wireless client, video properties of a video stream being transcoded, and the decoded network signaling information.

According to an exemplary embodiment of the present disclosure, a method for simultaneously transcoding a plurality of video streams includes monitoring ongoing traffic in a cellular network, decoding network signaling information in the cellular network, receiving a service agreement from each of a plurality of wireless clients in the cellular network, and transcoding the plurality of video streams simultaneously upon determining that the ongoing traffic exceeds a backhaul bandwidth of the cellular network, the backhaul bandwidth is equal to a predefined threshold, or the ongoing traffic includes substantial congestion or packet loss. The transcoding is based on the decoded network signaling information and the service agreement corresponding to each of the plurality of wireless clients receiving a video stream.

### BRIEF DESCRIPTION OF THE SEVERAL VIEWS OF THE DRAWINGS

Exemplary embodiments of the present disclosure will be described below in more detail, with reference to the accompanying drawings:

FIG. 1 is a diagram of a cellular network employing a video service manager, according to an exemplary embodiment of the present disclosure.

FIG. 2 is a diagram of a cellular network employing a video service manager, according to an exemplary embodiment of the present disclosure.

FIG. 3A is a diagram of a video service manager, according to the exemplary embodiment of the present disclosure shown in FIG. 1.

FIG. 3B is a diagram of a video service manager, according to the exemplary embodiment of the present disclosure shown in FIG. 2.

FIG. 4 is a flowchart of a method for wireless video streaming, according to an exemplary embodiment of the present disclosure.

FIG. 5 is a computer system for implementing a method for wireless video streaming, according to an exemplary embodiment of the present disclosure.

### DETAILED DESCRIPTION

Exemplary embodiments of the present disclosure now will be described more fully hereinafter with reference to the accompanying drawings. This disclosure, may however, be embodied in many different forms and should not be construed as limited to embodiments set forth herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

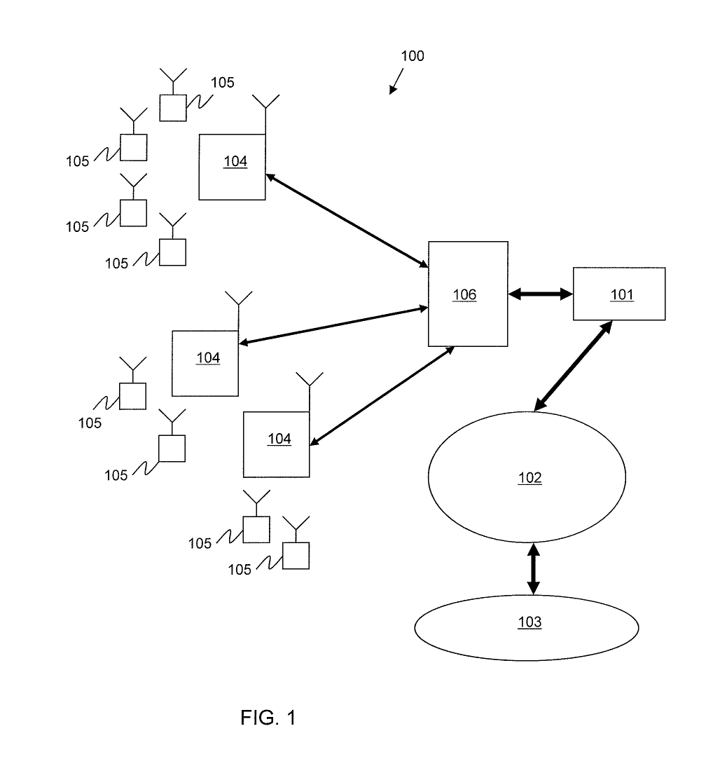

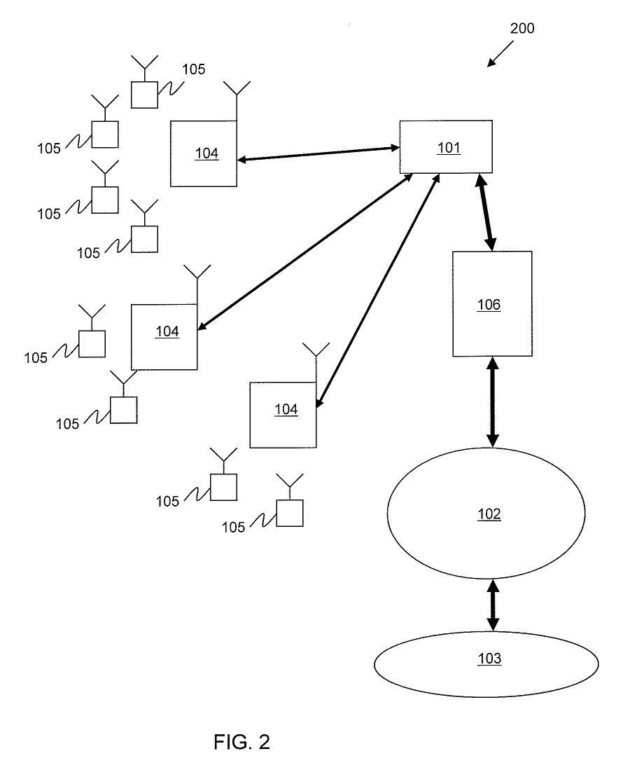

FIGS. 1 and 2 are diagrams of a cellular network employing a video service manager, according to exemplary embodiments of the present disclosure.

Referring to FIG. 1, a cellular network 100 may include a base station controller 101 connected to a core network 102 of the cellular network 100. The core network 102 is connected to the Internet 103, and provides an interne connection to the base station controller 101. The base station controller 101 is in communication with a group of base stations 104 (e.g., cellular towers). The base station controller 101 provides a backhaul bandwidth of about 3-5 Mbps to each base station 104 in a 3G cellular network, and a backhaul bandwidth of about 300 Mbps in a 4G cellular network (e.g., an LTE cellular network or a WiMAX cellular network). Each base station 104 provides a cellular connection to a plurality of wireless clients 105 (e.g., cellular phones). For example, each base station 104 may connect about 1,000 wireless clients 105 to the core network 102. About 200 of these wireless clients 105 may be active at any given time. Since video content is typically encoded with a bit rate of about 400 Kbps for standard definition video and 2-4 Mbps for high definition video, the limited backhaul bandwidth of both 3G and 4G cellular networks results in the inability to adequately provide video streams to a large number of wireless clients 105. For example, a base station 104 in a 3G cellular network can only provide streaming standard definition video to about 10 wireless clients 105 at a time, and a base station 104 in a 4G cellular network can only provide streaming high definition video to about 100 wireless clients 105 at a time.

The cellular network 100 may further include a video service manager 106 connected between the base station controller 101 and the group of base stations 104. The video service manager 106 may implement video transcoding and statistical multiplexing to efficiently utilize network bandwidth when streaming video to the wireless clients 105. Efficient utilization of network bandwidth improves the video streaming service quality for users of the cellular network 100.

In the exemplary embodiment shown in FIG. 1, the video service manager 106 is located between the base station controller 101 and the base stations 104. This configuration allows the video service manager 106 to inspect the traffic between the base station controller 101 and the base stations 104, and analyze the network signaling information (e.g., cellular network signaling information) in the cellular network 100. The video service manager 106 may adjust the manner in which data is transmitted via the cellular network 100 based on the network signaling information, the backhaul bandwidth, and service agreements of the wireless clients 105. The video service manager 106 may be installed at other locations of the cellular network 100, as appreciated by those having ordinary skill in the related art. For example, as shown in FIG. 2, the video service manager 106 may be located between the base station controller 101 and the core network 102. This configuration allows the video service manager 106 to inspect the traffic between the base station controller 101 and the core network 102, and analyze the network signaling to obtain information relating to the ongoing traffic of each wireless client 105. The video service manager 106 may adjust the manner in which data is transmitted via the cellular network 200 based on the collected traffic information.

The video service manager 106 monitors, decodes and analyzes the network signaling information transmitted between the base stations 104 and the base station controller 101 (see FIG. 1), or between the base station controller 101 and the core network 102 (see FIG. 2). For example, the video service manager 106 may monitor, decode and analyze A9 standardized network signaling information that is typically utilized in a CDMA2000 cellular network, as well as other types of standardized network signaling information used in other types of cellular networks such as, for example, a 3^{rd} Generation Partnership Project (3GPP) cellular network. The video service manager 106 may further extract certain information from the network signaling information. For example, the video service manager 106 may distinguish between different types of data streams intended for the wireless clients 105 by extracting information including, but not limited to, the session identification (ID), base station ID and user mobile ID, from the network signaling information associated with each of the wireless clients 105. Inspecting the network signaling information allows the video service manager 106 to determine the data types and bandwidth usage of each wireless client 105 connected to each of the respective base stations 104. The video service manager 106 may further analyze the header packets of a video stream to determine information relating to the video stream including, but not limited to, the bit rate and the frame rate of the stream.

The video service manager 106 monitors the ongoing traffic and available bandwidth between a base station 104 and the wireless clients 105 connected to the base station 104. If the video service manager 106 determines that the available backhaul bandwidth of a particular base station 104 is insufficient to support the traffic between the base station 104 and the connected wireless clients 105, the video service manager 106 dynamically and simultaneously transcodes the active video streams transmitted to the base station 104 by the base station controller 101. The active video streams are transcoded such that the overall bit rate of the active streams does not exceed the available backhaul bandwidth of the base station 104. For example, the active video streams may be transcoded when the aggregated data rate of the ongoing traffic exceeds the backhaul bandwidth or is equal to a predefined threshold, or when the ongoing traffic has substantial congestion or packets loss.

Transcoding a video stream may include, but is not limited to, reducing the frame rate of the video stream by dropping B frames from the stream, dropping the enhancement layer in scalable video coding, reducing the bit rate of the video stream, or reducing the video resolution to a lower resolution (e.g., transcoding a high definition video to a standard definition video). Transcoding the video streams may be based on the ongoing traffic, user analysis, and the service agreement of each user.

The video service manager 106 may implement statistical multiplexing during the transcoding process. Statistical multiplexing results in the total available backhaul bandwidth of a base station 104 being shared more efficiently among multiple video streams transmitted via the base station 104. Statistical multiplexing, when applied to a large number of video streams (e.g., about 10 video streams or more), may result in bit rate gains by a factor of 2, which reduces the bandwidth needed by about half on average for the transmission of video between the base station controller 101 and the base stations 104. Multiple video streams may be transcoded in parallel, and may be transcoded using different transcoding algorithms and parameters. For example, transcoding a first active video stream may include dropping B frames from the video stream, transcoding a second active video stream may include reducing the frame rate of the video stream, transcoding a third active video stream may include reducing the bit rate of the video stream, and transcoding a fourth active video stream may include reducing the video resolution of the video stream. A video stream may be transcoded using a combination of different transcoding algorithms.

According to an exemplary embodiment, the video service manager 106 collects information related to the wireless clients 105 (e.g., the service agreement of each of the wireless clients 105) and information related to the ongoing traffic between a base station 104 and the connected wireless clients 105 (e.g., video properties of the video streams being streamed to the wireless clients 105 via the base station 104). This information may be analyzed by the video service manager 106 to dynamically determine how each of the multiple video streams being transmitted to different wireless clients 105 should be transcoded. Thus, using statistical multiplexing, multiple video streams may be simultaneously and dynamically transcoded more efficiently using available transcoding algorithms and parameters.

In an exemplary embodiment, multiple video streams may be transcoded based on the respective service agreements of wireless clients 105. For example, a first wireless client 105 may have a service agreement granting it premium access to the cellular network 100, while a second wireless client 105 may have a service agreement granting it basic access to the network 100. Video content transmitted to each of these wireless clients 105 may be transcoded differently based on the respective service agreements of each of the wireless clients 105. Thus, if video content is being transmitted to a first wireless client 105 having a premium service agreement and a second wireless client 105 having a basic service agreement, the video content transmitted to the second wireless client 105 will be transcoded in a more aggressive fashion than the video content transmitted to the first wireless client 105. For example, if the video service manager 106 determines that the available backhaul bandwidth of the base station 104 serving the video streams to the two wireless clients 105 is insufficient, the video service manager 106 may dynamically reduce the frame rate, bit rate, or video resolution of the video content transmitted to the second wireless client 105 before reducing the frame rate, bit rate, or video resolution of the video content transmitted to the first wireless client 105.

In an exemplary embodiment, multiple video streams may be transcoded in parallel based on the video properties of each individual video stream. For example, if a first video stream includes standard definition video content, and a second video stream includes high definition video content, the video service manager 106 may reduce the video resolution of the second video stream rather than reducing the video resolution of the first video stream, since the degradation in quality resulting from transcoding a high definition video into a standard definition video is more acceptable than the degradation in quality resulting from reducing the video resolution of video content already encoded as a standard definition video. Similarly, the video service manager 106 may reduce the frame rate or bit rate of video content already encoded with a high frame rate or bit rate before reducing the frame rate or bit rate of video content encoded with a lower frame rate or bit rate. The video service manager 106 may utilize both the service agreements of wireless clients 105 and the video properties of individual video streams when transcoding multiple video streams.

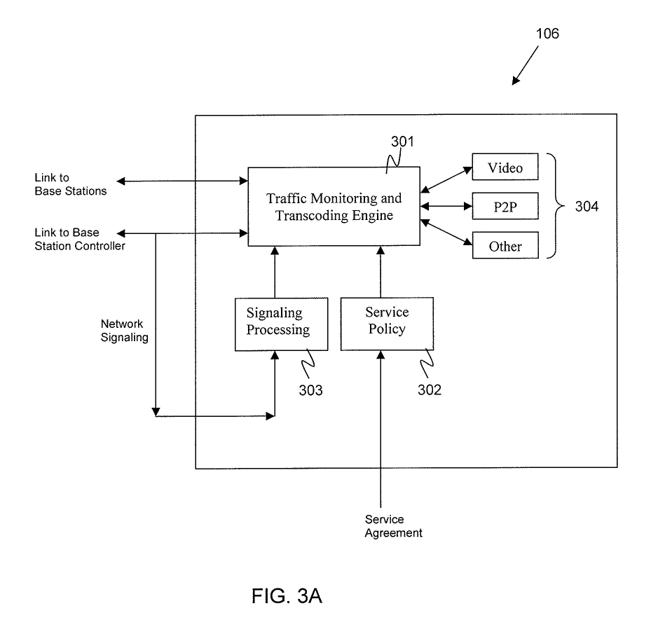

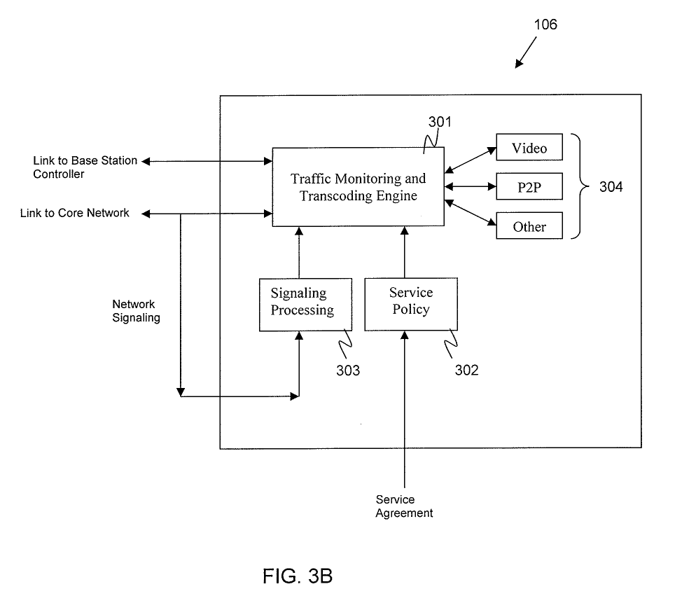

FIG. 3A is a diagram of a video service manager 106, according to the exemplary embodiment shown in FIG. 1. FIG. 3B is a diagram of a video service manager 106 according to the exemplary embodiment shown in FIG. 2.

Referring to FIGS. 3A and 3B, a video service manager 106 includes a traffic monitoring and transcoding engine 301, a service policy component 302, and a signaling processing component 303. The traffic monitoring and transcoding engine 301 is linked to the base stations 104 and the base station controller 101 in FIG. 3A, and is linked to the base station controller 101 and the core network 102 in FIG. 3B. The wireless clients 105 may request a certain service from the traffic monitoring and transcoding engine 301 such as, for example, video service, peer-to-peer (P2P) service, audio service, or text messaging service. Because different service requests utilize different amounts of bandwidth (e.g., P2P services typically require large amounts of bandwidth), the traffic monitoring and transcoding engine 301 parses the service requests into multiple categories 304. In addition to receiving requests for services from the wireless clients 105, the video service manager 106, by way of the signaling processing component 303, receives standardized network signaling information from the base station controller 101 or the core network 102 and decodes the standardized network signaling information to identify, for example, the session ID, base station ID, and user mobile ID for each wireless client 105, however the type of information identified is not limited thereto (e.g., because a CDMA2000 cellular network utilizes A9 standardized network signaling, the signaling processing component 303 is capable of analyzing and extracting A9 standardized network signaling information). For example, the signaling processing component 303 decodes network signaling information and builds an association between the wireless clients 105, the base stations 104 connecting the respective wireless clients 105 to the cellular network 100, and the data streams transferred between the base stations 104 and the respective wireless clients 105 (e.g., the signaling processing component 303 may determine that a wireless client 105 having a user mobile ID of 25 is connected to the cellular network via a base station 104 having a base station ID of 32, and is receiving a video stream via a connection having a session ID of 16). The associated network signaling information is transmitted from the signaling processing component 303 to the traffic monitoring and transcoding engine 301. The traffic monitoring and transcoding engine 301 parses the header packets of the video stream to identify the video parameters, such as, for example, bit rate, frame rate, or video resolution. The service policy component 302 receives the service agreements of each wireless client 105, determines the video transcoding policy for each wireless client 105 based on the respective service agreements, and transmits the transcoding policy to the traffic monitoring and transcoding engine 301. As described above, the service agreements of the wireless clients, the video properties of the video streams, and the network signaling information are used to dynamically and simultaneously transcode multiple video streams in parallel.

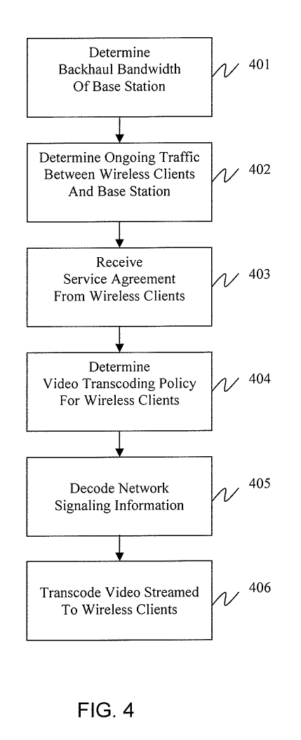

FIG. 4 is a flowchart of a method for wireless video streaming, according to an exemplary embodiment of the present disclosure.

Referring to FIG. 4, the backhaul bandwidth of each base station 104 is determined at block 401. The backhaul bandwidth is the maximum bandwidth available for each base station 104, and is shared amongst all wireless clients 105 connected to each base station 104. At block 402, the ongoing traffic between the wireless clients 105 and the base stations 104 is determined. At block 403, a service agreement of each wireless client 105 is received. At block 404, a video transcoding policy is determined for each wireless client 105. The video transcoding policies are determined based on the respective service agreements of each wireless client 105. At block 405, the network signaling information is decoded. At block 406, video content streamed to the wireless clients 105 is transcoded upon determining that the ongoing traffic exceeds the backhaul bandwidth or is equal to a predefined threshold, or when the ongoing traffic includes substantial congestion or packet loss. The video content is transcoded based on the transcoding policy of each wireless client 105, the decoded network signaling information, and the video properties of the video content.

The flowcharts and block diagrams in the figures illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

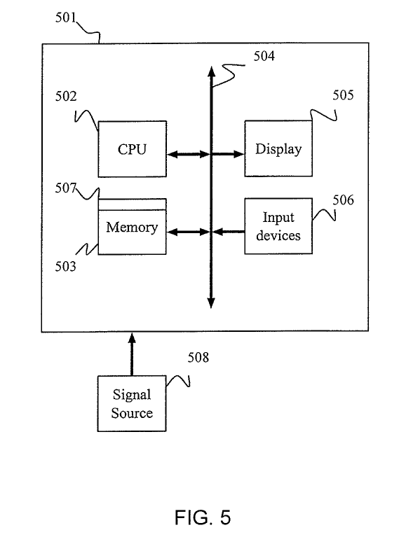

More particularly, referring to FIG. 5, according to an exemplary embodiment of the present disclosure, a computer system 501 for wireless video streaming quality management for a bandwidth constrained cellular network can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. Embodiments of present disclosure may be implemented as a routine 507 stored in memory 503 (e.g., a non-transitory computer-readable storage medium) and executed by the CPU 502 to process the signal from the signal source 508. As such, the computer system 501 is a general-purpose computer system that becomes a specific purpose computer system when executing the routine 507 of the present disclosure.

The computer platform 501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described embodiments for wireless video streaming quality management for a bandwidth constrained cellular network, it is noted that modifications and variations can be made by persons skilled in the art in light of the above teachings. It is therefore to be understood that changes may be made in exemplary embodiments of the disclosure, which are within the scope and spirit of the disclosure as defined by the appended claims. Having thus described exemplary embodiments of the disclosure with the details and particularity required by the patent laws, what is claimed and desired protected by Letters Patent is set forth in the appended claims.

What is claimed is:

1. A method for wireless video streaming, comprising:
determining a backhaul bandwidth of a base station;
determining ongoing traffic between a plurality of wireless clients and the base station;
determining a video transcoding policy for each of the plurality of wireless clients based on a service agreement corresponding to each of the plurality of wireless clients;
decoding network signaling information;
extracting a plurality of video streams, based on the decoded network signaling information; and
transcoding the plurality of video streams simultaneously upon determining that the ongoing traffic exceeds the backhaul bandwidth, wherein the transcoding is based on a video transcoding policy of a receiving wireless client, video properties of a video stream being transcoded, and the decoded network signaling information.

2. The method of claim 1, wherein decoding network signaling information comprises identifying a session identification (ID), a base station ID, and a user mobile ID for each of the plurality of wireless clients.

3. The method of claim 1, wherein statistical multiplexing is utilized to transcode the plurality of video streams using different transcoding parameters.

4. The method of claim 3, further comprising dynamically adjusting the different transcoding parameters used to transcode the plurality of video streams in response to a change in the ongoing traffic.

5. The method of claim 3, wherein the different transcoding parameters comprise at least one of reducing a frame rate of the plurality of video streams, reducing a bit rate of the plurality of video streams, reducing a video resolution of the plurality of video streams, dropping B frames from the plurality of video streams, and removing an enhancement layer from the plurality of video streams.

6. The method of claim 1, wherein the video properties of a video stream are determined by parsing video parameters from header packets of the video stream.

7. The method of claim 6, wherein the video parameters include at least one of a bit rate, a frame rate, or a video resolution.

8. The method of claim 1, wherein the extracted plurality of video streams are identified based on a session identification (ID), a base station ID, and a user mobile ID associated with each of the plurality of wireless clients.

9. A video service manager, comprising:
a service policy component configured to determine a video transcoding policy for each of a plurality of wireless clients based on a service agreement corresponding to each of the plurality of wireless clients;
a signaling processing component configured to decode network signaling information, and extract a plurality of video streams based on the decoded network signaling information; and
a traffic monitoring and transcoding engine configured to transcode the plurality of video streams simultaneously upon determining that ongoing traffic between the plurality of wireless clients and a base station exceeds a backhaul bandwidth of the base station, wherein the transcoding is based on a video transcoding policy of a receiving wireless client, video properties of a video stream being transcoded, and the decoded network signaling information.

10. The video service manager of claim 9, wherein the signaling processing component is configured to identify a session identification (ID), base station ID, and user mobile ID for each of the plurality of wireless clients.

11. The video service manager of claim 9, wherein the traffic monitoring and transcoding engine is configured to perform at least one of reducing a frame rate of the plurality of video streams, reducing a bit rate of the plurality of video streams, reducing a video resolution of the plurality of video streams, dropping B frames from the plurality of video streams, and removing an enhancement layer from the plurality of video streams.

12. The video service manager of claim 9, wherein the video service manager is disposed between the plurality of wireless clients and a base station controller in a cellular network.

13. The video service manager of claim 9, wherein the video service manager is disposed between a base station controller and a core network in a cellular network.

14. The video service manager of claim 9, wherein the traffic monitoring and transcoding engine is configured to utilize statistical multiplexing to transcode the plurality of video streams using different transcoding parameters.

15. The video service manager of claim 14, wherein the traffic monitoring and transcoding engine is configured to dynamically adjust the different transcoding parameters in response to a change in the ongoing traffic.

16. The video service manager of claim 9, wherein the traffic monitoring and transcoding engine is configured to identify video properties of the plurality of video streams by parsing video parameters from header packets of the plurality of video streams.

17. The video service manager of claim 16, wherein the video parameters include at least one of a bit rate, a frame rate, or a video resolution.

18. The video service manager of claim 9, wherein the signaling processing component is configured to identify the extracted plurality of video streams based on a session identification (ID), a base station ID, and a user mobile ID associated with each of the plurality of wireless clients.

19. A method for simultaneously transcoding a plurality of video streams, comprising:
monitoring ongoing traffic in a cellular network;
decoding network signaling information in the cellular network;
receiving a service agreement from each of a plurality of wireless clients in the cellular network; and
transcoding the plurality of video streams simultaneously upon determining that the ongoing traffic exceeds a backhaul bandwidth of the cellular network, the backhaul bandwidth is equal to a predefined threshold, or the ongoing traffic includes substantial congestion or packet loss,
wherein the transcoding is based on the decoded network signaling information and the service agreement corresponding to each of the plurality of wireless clients receiving a video stream.
